(19) United States
(12) Patent Application Publication
(10) Pub. No.: US 2026/0301763 A1
(43) Pub. Date: Oct. 1, 2026

(54) CROWD-SOURCED CURATION AND TRAINING OF AI MODELS FOR KARAOKE-STYLE PERFORMANCES

(71) Applicant: SMULE, INC., San Francisco, CA (US)

(72) Inventors: Jeffrey C. Smith, San Francisco, CA (US); Martin Boyanov, Sofia (BG); Randal J. Leistikow, Windsor, CO (US); Perry R. Cook, Jacksonville, OR (US); Yongyi Zang, Seattle, WA (US)

(21) Appl. No.: 19/578,480

(22) Filed: Mar. 25, 2026

Related U.S. Application Data
(60) Provisional application No. 63/777,334, filed on Mar. 25, 2025.

(51) Int. Cl. G10L 25/60; G10H 1/00; G10L 25/30

(52) U.S. Cl. CPC G10L 25/60; G10H 1/0025; G10L 25/30; G10H 2250/311

(57) ABSTRACT

Digital signal processing and artificial intelligence (AI)-based techniques can be employed in a vocal capture and performance social network to computationally train AI models using vocal audio performances sourced from one or more performers and captured at respective vocal capture devices or platforms. In particular, the AI models may be trained using a curated set of the vocal audio performances, where the curated set is selected based on correspondence with computationally-derived features, metadata, other associated features, or a combination thereof, of a style or character of a target performance. In this way, the thusly trained AI models may be deployed for use in vocal transformations of subsequent karaoke-style vocal audio captures into transformed vocal performances that have the style or character of the target performance.

### CROSS-REFERENCE TO RELATED APPLICATIONS

This application claims the benefit of U.S. Provisional Application No. 63/777,334, filed Mar. 25, 2025, the disclosure of which is incorporated by reference herein in its entirety.

### BACKGROUND

### Field of the Invention

The invention relates generally to processing of audio performances and, in particular, to computational techniques suitable for training artificial intelligence (AI) models using curated sets of vocal audio performances sourced from a plurality of performers and captured at a respective plurality of vocal capture platforms, and using the trained AI models for subsequent vocal transformations.

### Description of the Related Art

The installed base of mobile phones, personal media players, and portable computing devices, together with media streamers and television set-top boxes, grows in sheer number and computational power each day. Hyper-ubiquitous and deeply entrenched in the lifestyles of people around the world, many of these devices transcend cultural and economic barriers. Computationally, these computing devices offer speed and storage capabilities comparable to engineering workstation or workgroup computers from less than ten years ago, and typically include powerful media processors, rendering them suitable for real-time sound synthesis and other musical applications. Partly as a result, some modern devices, such as iPhone^{®}, iPad^{®}, iPod Touch^{®} and other iOS^{®} or Android devices, support audio and video processing quite capably, while at the same time providing platforms suitable for advanced user interfaces. Indeed, applications such as the Smule Ocarina^{TM}, AutoRap^{®}, Sing! Karaoke^{TM} (now Smule^{®} Karaoke), Smule^{®} Style Studio, and Magic Piano^{®} apps available from Smule, Inc. have shown that advanced digital acoustic techniques may be delivered using such devices in ways that provide compelling musical experiences.

One application domain in which exploitations of digital acoustic techniques have proven particularly successful is audiovisual performance capture, including karaoke-style capture of vocal audio. Some features of advanced karaoke-style vocal capture implementations and, indeed, some compelling aspects of the user experience thereof, include provision of performance-synchronized (or synchronizable) vocal pitch cues, real-time continuous pitch correction of captured vocal performances, auto-harmony generation, user performance grading, competitions, etc.

With the proliferation of artificial intelligence (AI) models and the bevy of possible AI-based applications for development, opportunities for new vocal capture applications designed to appeal to a mass market, and which offer additional compelling user experience features, have grown quite rapidly. To support these and other features, automated and/or semi-automated techniques are desired for AI-assisted production of vocal tracks for use in mass-market, karaoke-style vocal capture applications.

### SUMMARY

It has been discovered that digital signal processing and artificial intelligence (AI)-based techniques, such as machine learning and deep learning techniques, can be employed in a karaoke-style vocal capture and performance social network to computationally train AI models using vocal audio performances sourced from one or more performers and captured at respective vocal capture devices or platforms. In particular, the AI models may be trained using a curated set of the vocal audio performances, where the curated set is selected based on correspondence with computationally-derived features, metadata, other associated features, or a combination thereof, of a style or character of a target performance. In this way, the thusly trained AI models may be deployed for use in vocal transformations of subsequent karaoke-style vocal audio captures into transformed vocal performances that have the style or character of the target performance.

In some embodiments in accordance with the present invention(s), a method includes curating a dataset of computer readable encodings of dry vocal performances each captured against one or more respective temporally-synchronized tracks. In some embodiments, the method further includes based on one or more of correspondence of metadata associated with respective ones of the dry vocal performances, correspondence of a set of computationally-derived features extracted from the computer readable encodings of respective dry vocal performances, and correspondence of amongst one or more of the respective temporally-synchronized tracks against which respective ones of the dry vocal performances were captured, selecting from the dataset a subset of the dry vocal performances as a first training set that embodies a first target performance style or character. In some embodiments, the method further includes, using a first trained neural network model trained with the first training set, generating from at least speech content representations extracted from a newly captured dry vocal performance, a transformed vocal performance corresponding to the newly captured dry vocal performance but with the style or character of the first target performance.

In some embodiments, the method further includes, using a second trained neural network model trained with a second training set, generating from at least speech content representations extracted from the newly captured dry vocal performance, a second transformed vocal performance corresponding to the newly captured dry vocal performance but with the style or character of a second target performance. In some embodiments, the second training set is a second subset of the dry vocal performances selected from the dataset that embodies the second target performance style or character.

In some embodiments, selecting from the dataset includes selecting plural subsets of the dry vocal performances as respective plural training sets that each embody a respective target performance style or character, and the method further includes selecting, from amongst plural trained neural network models trained with one of the respective plural training sets, a second trained neural network model. In some embodiments, the method further includes, using the second trained neural network model, generating from at least speech content representations extracted from the newly captured dry vocal performance, a second transformed vocal performance corresponding to the newly captured dry vocal performance but with the style or character of the respective target performance.

In some embodiments, the method further includes capturing the newly captured dry vocal performance and generating the transformed vocal performance at a mobile audiovisual capture device.

In some embodiments, the method further includes receiving a computer readable encoding of the newly captured dry vocal performance at a service platform from a mobile audiovisual capture device, generating the transformed vocal performance at the service platform, and supplying a computer readable encoding of the transformed vocal performance to the mobile audiovisual capture device for audible rendering thereon.

In some embodiments, each of the selected dry vocal performances of the first training set were previously captured from a single performer.

In some embodiments, each of the selected dry vocal performances of the first training set were previously captured from a different performer at a respective mobile audiovisual capture device.

In some embodiments, the temporally-synchronized tracks include one or more of a backing track, a score track, and a lyrics track against which the respective dry vocal performance was captured.

In some embodiments, the metadata encodes one or more of performer identity, community-applied style tags, likes or follows, genre, popularizing artist, geotag location data, gender, age, and backing track identifier.

In some embodiments, the computationally-derived features include one or more of pitch features, quality features, phoneme features, or a predicted genre.

In some embodiments, the computationally-derived features further include emotional or affective features.

In some embodiments, the first target performance style or character embodied by the first training set characterizes performances of a particular performer.

In some embodiments, the first target performance style or character embodied by the first training set corresponds to a particular vocal style, cadence or tonal quality.

In some embodiments, the first target performance style or character embodied by the first training set includes multiple harmonic vocals.

In some embodiments, the method further includes pre-processing at least some of the computer readable encodings of the respective dry vocal performances using a neural network model trained to cancel backing track bleed through, equalize a vocal signal and/or eliminate extraneous, non-vocal audio.

In some embodiments, the first trained neural network model includes a generative adversarial network (GAN) or a diffusion model.

In some embodiments, the speech content representations include one or more of a textual content, a vocal accent, a vocal timing, and phonemes.

In some embodiments, the method further includes mixing the transformed vocal performance with a backing track to generate a mixed vocal performance.

In some embodiments, the mixing the transformed vocal performance with the backing track to generate the mixed vocal performance is performed at mobile audiovisual capture device.

In some embodiments, the mixing the transformed vocal performance with the backing track to generate a mixed vocal performance is performed at a service platform.

In some embodiments, the first training set includes vocal audio that is synthetically generated based on the subset of the dry vocal performances.

In some embodiments, the transformed vocal performance is generated in a real-time during capture of the newly captured dry vocal performance.

In some embodiments, the newly captured dry vocal performance includes spoken-word audio.

In some embodiments, the transformed vocal performance includes a hybrid vocal style corresponding to the newly captured dry vocal performance but with the style or character of both the first target performance and a second target performance.

In some embodiments, a first temporal segment of the transformed vocal performance corresponds to the newly captured dry vocal performance but with the style or character of the first target performance, and wherein a second temporal segment of the transformed vocal performance corresponds to the newly captured dry vocal performance but with the style or character of a second target performance.

In some embodiments, the transformed vocal performance includes vocal audio corresponding to a language or an accent different than that of the newly captured dry vocal performance.

In some embodiments in accordance with the present invention(s), a computer program product is encoded in one or more media, the computer program product including instructions executable on one or more processors to perform the methods described above.

In some embodiments in accordance with the present invention(s), a method includes accessing computer readable encodings of respective dry vocal performances each captured in connection with one or more respective temporally-synchronized tracks. In some embodiments, the method further includes extracting a set of computationally-derived features and metadata from each of the computer readable encodings of the respective dry vocal performances. In some embodiments, the method further includes selecting from the computer readable encodings of the respective dry vocal performances, a subset of the dry vocal performances to define a training dataset, where the subset of dry vocal performances is selected for correspondence with at least one of the computationally-derived features and the metadata of the respective dry vocal performances. In some embodiments, the method further includes training a neural network model using the training dataset to generate a trained neural network model. In some embodiments, the method further includes receiving a newly captured computer readable encoding of a dry vocal performance. In some embodiments, the method further includes converting, using the trained neural network model, the newly captured dry vocal performance into a modified vocal performance corresponding to the newly captured dry vocal performance but having correspondence with the at least one of the computationally-derived features and the metadata of the respective dry vocal performances.

In some embodiments, the method further includes selecting from the computer readable encodings of the respective dry vocal performances, a second subset of the dry vocal performances to define a second training dataset, where the second subset of dry vocal performances is selected for correspondence with at least a different one of the computationally-derived features and the metadata of the respective dry vocal performances. In some embodiments, the method further includes training a second neural network model using the second training dataset to generate a second trained neural network model. In some embodiments, the method further includes converting, using the second trained neural network model, the newly captured dry vocal performance into a second modified vocal performance corresponding to the newly captured dry vocal performance but having correspondence with the at least the different one of the computationally-derived features and the metadata of the respective dry vocal performances.

In some embodiments, the method further includes selecting from the computer readable encodings of the respective dry vocal performances, plural subsets of the dry vocal performances to define respective plural training datasets, where each of the plural subsets of the dry vocal performances are selected for correspondence with respective sets of the computationally-derived features and the metadata of each the respective dry vocal performances. In some embodiments, the method further includes training plural neural network models using the respective plural training datasets to generate plural trained neural network models. In some embodiments, the method further includes converting, using a selected one of the plural trained neural network models, the newly captured dry vocal performance into a second modified vocal performance corresponding to the newly captured dry vocal performance but having correspondence with the respective set of the computationally-derived features and the metadata of the respective dry vocal performances of a respective training dataset used to train the selected one of the plural trained neural network models.

In some embodiments, the set of computationally-derived features include pitch features, quality features, phoneme features, or a predicted genre.

In some embodiments, the metadata includes one or more of performer identity, community-applied style tags, likes or follows, genre, popularizing artist, geotag location data, gender, age, and backing track identifier.

In some embodiments, the method further includes prior to training the neural network model, performing one or more of a pitch range filtering process, a bleed removal process, and an audio restoration process to the subset of dry vocals of the dataset to define a pre-processed dataset, and training the neural network model using the pre-processed dataset to generate the trained neural network model.

In some embodiments, each of the dry vocal performances of the training dataset were previously captured from a single performer.

In some embodiments, at least some of the dry vocal performances of the training dataset were previously captured from different performers.

In some embodiments, the method further includes capturing the newly captured computer readable encoding of the dry vocal performance at a mobile handheld device.

In some embodiments, the converting the newly captured dry vocal performance into the modified vocal performance is performed at the mobile handheld device.

In some embodiments, the converting the newly captured dry vocal performance into the modified vocal performance is performed at a service platform.

In some embodiments, the method further includes mixing the modified vocal performance with a backing track to generate a mixed vocal performance.

In some embodiments, the mixing the modified vocal performance with the backing track to generate the mixed vocal performance is performed at a mobile handheld device.

In some embodiments, the mixing the modified vocal performance with the backing track to generate a mixed vocal performance is performed at a service platform.

In some embodiments, the neural network model includes a generative adversarial network (GAN) or a diffusion model.

In some embodiments in accordance with the present invention(s), a computer program product is encoded in one or more media, the computer program product including instructions executable on one or more processors to perform the methods described above.

In some embodiments in accordance with the present invention(s), a method includes capturing, via a microphone of a portable computing device, a vocal audio performance of a user of the portable computing device captured in connection with one or more respective temporally-synchronized tracks. In some embodiments, the method further includes transmitting a computer readable encoding of the vocal audio performance and a selection of a style or character of a target performance to a service platform. In some embodiments, the method further includes receiving, from the service platform for rendering at the portable computing device, a transformed vocal audio performance corresponding to the captured vocal audio performance of the user but with the style or character of the target performance. In some embodiments, the transformed vocal audio performance includes an output of a neural network model trained with a training dataset comprising previously recorded dry vocal performances each corresponding with at least one of plural computationally-derived features and metadata of the previously recorded dry vocal performances, and where the training dataset embodies the style or character of the target performance.

In some embodiments in accordance with the present invention(s), a system includes a geographically distributed set of network-connected devices configured to capture vocal audio performances captured in connection with a temporally-synchronized track. In some embodiments, the system further includes a service platform configured to (i) curate a dataset of computer readable encodings of dry vocal performances each captured against one or more respective temporally-synchronized tracks, (ii) based on one or more of correspondence of metadata associated with respective ones of the dry vocal performances, correspondence of a set of computationally-derived features extracted from the computer readable encodings of respective dry vocal performances, and correspondence of amongst one or more of the respective temporally-synchronized tracks against which respective ones of the dry vocal performances were captured, selecting from the dataset a subset of the dry vocal performances as a first training set that embodies a first target performance style or character, and (iii) using a first trained neural network model trained with the first training set, generating from at least speech content representations extracted from a newly captured dry vocal performance captured from one of the geographically distributed set of network-connected devices, a transformed vocal performance corresponding to the newly captured dry vocal performance but with the style or character of the first target performance.

In some embodiments, the service platform is further configured to transmit the transformed vocal performance to the one of the geographically distributed set of network-connected devices.

In some embodiments in accordance with the present invention(s), a system includes a geographically distributed set of network-connected devices configured to capture vocal audio performances captured in connection with a temporally-synchronized track. In some embodiments, the system further includes a service platform configured to (i) access computer readable encodings of respective dry vocal performances each captured in connection with one or more respective temporally-synchronized tracks, (ii) extract a set of computationally-derived features and metadata from each of the computer readable encodings of the respective dry vocal performances, (iii) select from the computer readable encodings of the respective dry vocal performances, a subset of the dry vocal performances to define a training dataset, where the subset of dry vocal performances is selected for correspondence with at least one of the computationally-derived features and the metadata of the respective dry vocal performances, (iv) train a neural network model using the training dataset to generate a trained neural network model, (v) receive a newly captured computer readable encoding of a dry vocal performance from at least one of the geographically distributed set of network-connected devices, and (vi) convert, using the trained neural network model, the newly captured dry vocal performance into a modified vocal performance corresponding to the newly captured dry vocal performance but having correspondence with the at least one of the computationally-derived features and the metadata of the respective dry vocal performances.

In some embodiments, the service platform is further configured to transmit the modified vocal performance to the at least one of the geographically distributed set of network-connected devices.

In some embodiments in accordance with the present invention(s), a method includes extracting, from computer readable encodings of dry vocal performances each captured in connection with one or more respective temporally-synchronized tracks, performance features associated with each of the dry vocal performances. In some embodiments, the method further includes creating a searchable performance features index for storing the extracted performance features associated with each of the dry vocal performances. In some embodiments, the method further includes searching the searchable performance features index to select a subset of dry vocal performances that each correspond to a chosen criteria of the extracted performance features, where the selected subset of dry vocal performance defines a training dataset that embodies a target performance style or character associated with the chosen criteria. In some embodiments, the method further includes using a trained neural network model trained with the training dataset, generating from at least speech content representations extracted from a newly captured dry vocal performance, a transformed vocal performance corresponding to the newly captured dry vocal performance but with the style or character of the target performance.

In some embodiments, the method further includes receiving a selection of the chosen criteria from a mobile audiovisual capture device, and based on the selection, searching the searchable performance features index to select the subset of dry vocal performances that each correspond to the chosen criteria of the extracted performance features.

In some embodiments, the extracted performance features include computationally-derived features and metadata.

In some embodiments, the chosen criteria is associated with traits from multiple performers or multiple tracks.

These and other embodiments in accordance with the present invention(s) will be understood with reference to the description and appended claims which follow.

### BRIEF DESCRIPTION OF THE DRAWINGS

The present invention(s) are illustrated by way of examples and not limitation with reference to the accompanying figures, in which like references generally indicate similar elements or features.

FIG. 1 depicts information flows amongst illustrative mobile phone-type portable computing devices and a content server in accordance with some embodiments of the present invention.

FIG. 2 depicts an exemplary functional flow for a dataset curation process, in accordance with some embodiments of the present invention.

FIG. 3 depicts a general, exemplary training flow for a generative neural network model employed in accordance with some embodiments of the present invention.

FIG. 4 depicts a general, exemplary inference flow for a generative neural network model deployed in accordance with some embodiments of the present invention.

Skilled artisans will appreciate that elements or features in the figures are illustrated for simplicity and clarity and have not necessarily been drawn to scale. For example, the dimensions or prominence of some of the illustrated elements or features may be exaggerated relative to other elements or features in an effort to help to improve understanding of embodiments of the present invention.

### DESCRIPTION

Artificial intelligence (AI)-assisted vocal transformation systems in accordance with some embodiments of the present invention leverage an extremely large number of karaoke-style dry vocal performances (billions) of a very large number of songs (millions) to curate a dataset for training AI models for use in vocal transformations or generally for use in musical transformations. Such systems computationally extract, or otherwise determine, from computer readable encodings of a set of plural dry vocal performances captured against one or more respective temporally-synchronized tracks (e.g., such as a backing track, a score track, and/or a lyrics track), computationally-derived features and metadata from each of the dry vocal performances. A curated subset of dry vocal performances is then selected based on correspondence of the computationally extracted and/or otherwise determined features and metadata with a style or character of a target performance. One or more AI models may then be trained using the curated subset of dry vocal performances, and the one or more trained AI models can then be deployed for use in vocal transformations of additional karaoke-style vocal audio captures into transformed vocal performances that have the style or character of the target performance. In general, a variety of neural network models may be employed for training, using the curated subset of dry vocal performances, and for subsequent deployment. Without loss of generality, some examples of such neural network models include generative adversarial networks (GANs) and diffusion models.

### Karaoke-Style Vocal Performance Capture

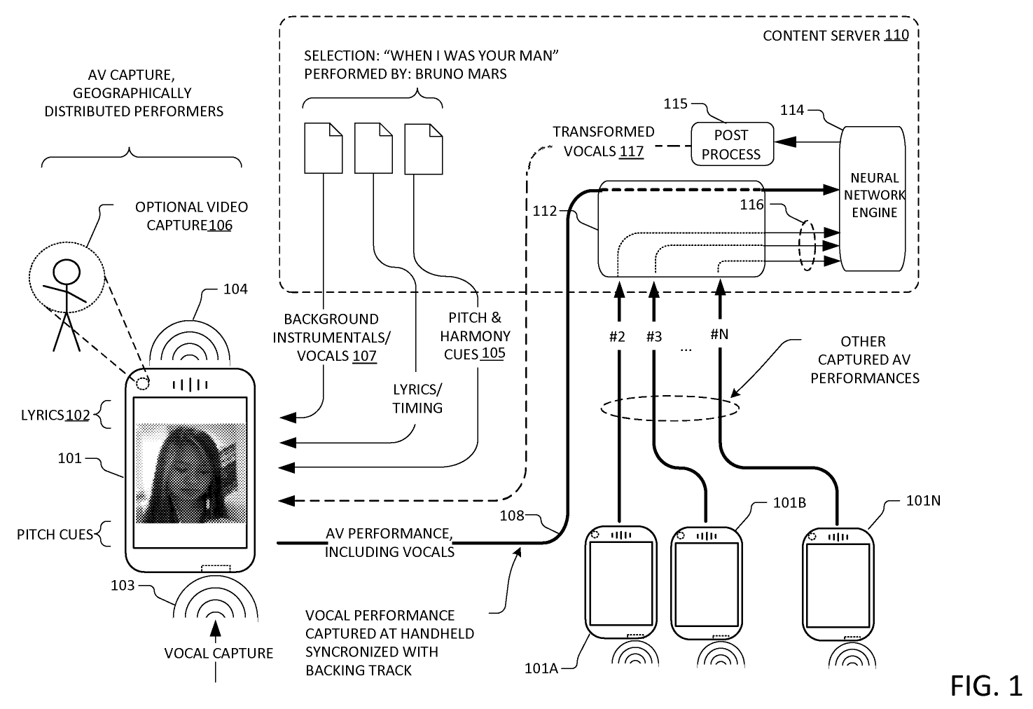

FIG. 1 depicts information flows amongst illustrative mobile phone-type portable computing devices (101, 101A, 101B … 101N) employed for vocal audio capture 103 (or in some cases, audiovisual capture 106) and a content server 110 in accordance with some embodiments of the present invention. The portable computing devices (101, 101A, 101B … 101N), in some embodiments, may provide a geographically distributed set of network-connected devices. In the illustrated flows, lyrics 102, pitch cues 105 and a backing track 107 are supplied to one or more of the portable computing devices (101, 101A, 101B … 101N) to facilitate the vocal audio capture 103 (or in some cases, audiovisual capture 106). Although embodiments of the present invention(s) are not limited thereto, pitch-corrected, karaoke-style, vocal capture using mobile phone-type audiovisual equipment provides a useful descriptive context.

For example, in some embodiments consistent with that illustrated in FIG. 1, an iPhone® handheld available from Apple Inc. (or more generally, handheld 101) hosts software that executes in coordination with the content server 110 to provide vocal capture and continuous real-time, score-coded pitch correction and harmonization of the captured vocals. Performance synchronized video may optionally be captured using an on-board camera provided by handheld 101. In some other embodiments, performance synchronized video may optionally be captured using a camera provided by, or in connection with, a television or other audiovisual media device or connected set-top box equipment such as an Apple TV^{TM} device. Content server 110 may be implemented as one or more physical servers, as virtualized, hosted and/or distributed application and data services, or using any other suitable service platform.

User vocals 103 are captured at handheld 101 and optionally pitch-corrected continuously and in real-time either at the handheld 101 or using computational facilities of an optionally connected audiovisual display and/or set-top box equipment and audibly rendered (see 104) mixed with the backing track to provide the user with an improved tonal quality rendition of his/her own vocal performance. Note that while captured vocals 103 and audible rendering 104 are illustrated using a convenient visual symbology that is centric on microphone and speaker facilities of handheld 101, persons of skill in the art having benefit of the present disclosure will appreciate that, in many cases, microphone and speaker functionality may be provided using attached or wirelessly-connected ear buds, headphones, speakers, feedback isolated microphones, etc. Accordingly, unless specifically limited, vocal capture and audible rendering should be understood broadly and without limitation to a particular audio transducer configuration.

Pitch correction, when provided, is typically based on score-coded note sets or cues (e.g., pitch and harmony cues 105), which provide continuous pitch-correction algorithms with performance synchronized sequences of target notes in a current key or scale. In addition to performance synchronized melody targets, score-coded harmony note sequences (or sets) can provide pitch-shifting algorithms with additional targets (typically coded as offsets relative to a lead melody note track and typically scored only for selected portions thereof) for pitch-shifting to harmony versions of the user’s own captured vocals. In some cases, pitch correction settings may be characteristic of a particular artist such as the artist that originally performed (or popularized) vocals associated with the particular backing track.

In addition, lyrics, melody and harmony track note sets and related timing and control information may be encapsulated as a score coded in an appropriate container or object (e.g., in a Musical Instrument Digital Interface, MIDI, or Java Script Object Notation, json, type format) for supply together with the backing track(s). Using such information, handheld 101, (and/or optionally connected audiovisual display and/or set-top box equipment) may display lyrics and even visual cues related to target notes, harmonies and currently detected vocal pitch in correspondence with an audible performance of the backing track(s) so as to facilitate a karaoke-style vocal performance by a user. Thus, if an aspiring vocalist selects “When I was your Man” as popularized by Bruno Mars, your_man.json and your_man.m4a may be downloaded from content server 110 (if not already available or cached based on prior download) and, in turn, used to provide background music, synchronized lyrics and, in some situations or embodiments, score-coded note tracks for continuous, real-time pitch-correction while the user sings.

Optionally, at least for certain embodiments or genres, harmony note tracks may be score coded for harmony shifts to captured vocals. Typically, a captured pitch-corrected (possibly harmonized) vocal performance together with performance synchronized video is saved locally, on the handheld 101, (and/or optionally connected audiovisual display and/or set-top box equipment), as one or more audiovisual files and is subsequently compressed and encoded for upload (108) to content server 110 as an MPEG-4 container file. MPEG-4 is an international standard for the coded representation and transmission of digital multimedia content for the Internet, mobile networks and advanced broadcast applications. Other suitable codecs, compression techniques, coding formats and/or containers may be employed if desired.

Depending on the implementation, encodings of dry vocals and/or pitch-corrected vocals may be uploaded (108) to content server 110. In general, such vocals (encoded, e.g., in an MPEG-4 container or otherwise) whether already pitch-corrected or pitch-corrected at content server 110 can then be mixed, e.g., with backing audio and other captured (and possibly pitch-shifted) vocal performances, to produce files or streams of quality or coding characteristics selected in accord with capabilities or limitations a particular target or network (e.g., handheld 101, 101A, 101B … 101N, optionally connected audiovisual display and/or set-top box equipment, a social media platform, etc.). Additionally, in at least some embodiments, mixing of the dry vocals and/or pitch corrected vocals, e.g., with backing audio and other captured (and possibly pitch-shifted) vocal performances, may be performed at handheld 101 prior to uploading (108) to the content server 110.

### AI-based singing system, generally

In accordance with embodiments of the present disclosure, and in the context of karaoke-style performance capture, as described above, multiple vocal audio performances (such as dry vocal audio performances) captured from a single performer using a single device (such as one of handheld 101A, 101B … 101N) or captured from multiple performers using multiple devices (such as plural ones of handheld 101A, 101B … 101N) are uploaded to the content server 110. The uploaded vocal audio performances are associated with respective user profiles and are processed using a digital signal processing module (112), implemented as part of a service platform (content server 110), and which is configured to perform a plurality of functions such as feature extraction, indexing, dataset curation, aggregation, and pre-processing, among others. The digital signal processing module (112) extracts, or otherwise determines, from computer readable encodings of the multiple dry vocal performances captured against one or more respective temporally-synchronized tracks (e.g., such as a backing track, a score track, and/or a lyrics track) and captured at one or more of the devices (such as plural ones of handheld 101A, 101B … 101N), computationally-derived features and metadata from each of the dry vocal performances. A curated subset of dry vocal performances 116 is then selected based on correspondence of the computationally extracted and/or otherwise determined features and metadata with a style or character of a target performance (e.g., such as a target singer, genre, character, a target voice type such as soprano, alto, tenor, or bass, anime, a target musical instrument voice such as sax, electric guitar, etc., or others). For purposes of this disclosure, a “target singer” or “target performance” includes a singer or performance (or a composite singer or composite performance) to which newly captured vocal audio (e.g., dry vocal audio captured at handheld 101 and uploaded 108 to content server 110) will be mapped (or transformed 117), for example, for subsequent rendering at handheld 101. It is noted that in various embodiments, the target performance may include vocal features of a single performer (e.g., singing style, voice, accent, pitch, etc.) that has uploaded their captured vocal performances to the content server 110, or the target performance may include a combination of vocal features from multiple performers to create a new composited voice (e.g., such as combining vocal features of a country singer and a Mexican singer to create a new voice of a country singer with a Mexican accent).

The curated dataset 116 defines a dataset that is provided for training of one or more neural network models (AI models, such as machine learning models and/or deep learning models) of a neural network engine 114. By way of example, the AI models may include generative models such as generative adversarial networks (GANs) and diffusion models. In some embodiments, the one or more trained AI models of the neural network engine 114 may then be employed in subsequent vocal audio captures to support (e.g., at a mobile phone-type portable computing device 101, or optionally at a media streaming device or set-top box) vocal transformations (117) of karaoke-style dry vocal audio performances, captured at handheld 101 and uploaded (108) to the content server 110, for processing by a trained AI model of the neural network engine 114 running an inference process on the uploaded dry vocal audio performances. In such a manner, the transformed vocal performances (117) will thus have the style or character of the target performance.

### Dataset creation and curation

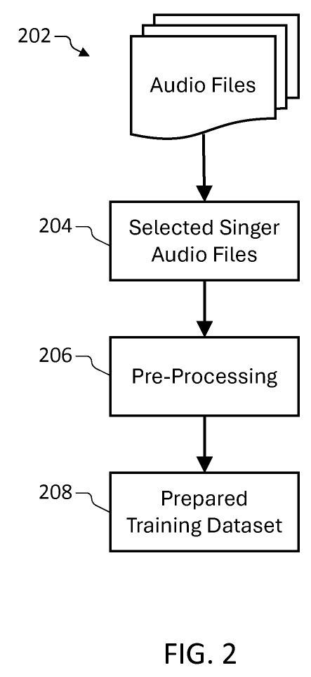

In some exemplary implementations of these techniques, a process flow optionally includes selection of particular vocal performances, followed by pre-processing of the selected individual performances to create a training dataset for one or more AI models. FIG. 2 depicts an exemplary functional flow for a dataset curation process, in accordance with some embodiments of the present invention. Particular steps of the functional flow are described in greater detail with reference to FIG. 2.

In general, a set, database or collection 202 of captured audio signal encodings of vocal performances (or audio files) is stored at, received by, or otherwise available to content server 110 or other service platform and individual captured vocal performances are, or can be, associated with metadata such as a performer identity, community-applied style tags, likes or follows, genre, popularizing artist, geotag location data, and/or additional user information such as gender or age. The individual captured vocal performances are, or can further be, associated with temporally-synchronized track identifiers such as a backing track identifier, a score track identifier, and/or a lyrics track identifier that identifies the backing track, score track, and lyrics track, respectively, against which the individual vocal performances were captured. Further, in some embodiments, computationally-derived features may be extracted, from computer readable encodings of the respective vocal performances, for some or all performances of the database or collection 202. Such computationally-derived features, by way of example, may include pitch features, quality features, phoneme features, or a predicted genre. In this manner, the individual captured vocal performances are, or can further be, associated with such computationally-derived features extracted from the captured vocal performances.

In various embodiments, the set, database or collection 202 of captured audio signal encodings of vocal performances may include an entire corpus of vocal performances (or audio files) stored at, or otherwise available to the content server 110. Alternatively, in some embodiments, the set, database or collection 202 of captured audio signal encodings of vocal performances may include a pre-curated set (which may be manually selected, in some cases) of vocal performances (or audio files) stored at, or otherwise available to the content server 110, where the pre-curated set of vocal performances may include a plurality of vocal performances by a given performer or a plurality of vocal performances by multiple performers.

In some cases or embodiments, the metadata, the temporally-synchronized track identifiers, and/or the computationally-derived features may be used to identify and select a subset of vocal performances (or audio files) 204 having desired characteristics (e.g., such as style or character) of a particular target singer (having an associated speaker/performer identification) or target performance. For example, based on one or more of correspondence of metadata associated with respective ones of the vocal performances, correspondence of a set of the computationally-derived features extracted from the computer readable encodings of respective vocal performances, and correspondence of amongst one or more of the respective temporally-synchronized tracks (identified by track identifiers) against which respective ones of the vocal performances were captured, the subset of vocal performances 204 can be identified and selected from the database or collection 202. As discussed in more detail below, the subset of vocal performances 204 may define a training set (or training dataset) that embodies the style or character of the particular target singer (having an associated speaker/performer identification) or target performance.

Also, in at least some embodiments, clustering techniques may be employed by performing audio feature extraction (computationally-derived feature extraction) and clustering the vocal performances using a spectral clustering algorithm to identify similar groups of vocal performances (e.g., such as singing styles, musical styles, etc.). In some cases, the subset of vocal performances 204 may be identified and selected from such groupings of vocal performances based on one or more of the metadata, the temporally-synchronized track identifiers, and/or the computationally-derived features, as described above. Persons of skill in the art having benefit of the present disclosure will appreciate a wide variety of selection criteria of the particular vocal performances (whether metadata-based, track identifier-based, audio-feature based, metadata-, track identifier-, and audio-feature based, or otherwise).

In accordance with embodiments of the present disclosure, the subset of vocal performances 204 provides accurate data for training AI models (voice cloning models) with specific characteristics. Stated another way, the subset of vocal performances 204 embodies a respective target performance style or character. Consider, as one example, curating a soprano voice. In such a case, audio recordings of singers with soprano voices may be initially selected (e.g., from the set, database or collection 202) and only those recordings (associated with a particular speaker/performer identity) where the selected singers are singing in the soprano range may be retained (e.g., as the subset of vocal performances 204). In this example, the metadata or computationally-derived features associated with the audio recordings, or a separate pitch range filtering process, may be used to select the audio recordings in which the selected singers are singing in the soprano range. Consider, as another example, curating a voice singing country music or anime songs. In such a case, audio recordings of singers who sing predominantly in these genres (country or anime, in this example) could be initially selected (e.g., from the set, database or collection 202) and only those recordings (associated with a particular speaker/performer identity) where the selected singers are singing in the selected genres may be retained (e.g., as the subset of vocal performances 204). In this example, the metadata or computationally-derived features associated with the audio recordings may be used to select the audio recordings in which the selected singers are singing in the selected genres. The selected subset of vocal performances 204, once identified, may define a training set (or training dataset) that embodies the style or character of the particular target singer or target performance (e.g., such as a soprano voice, or such as country or anime genres, in the above examples).

Generally, and in accordance with embodiments of the present disclosure, the metadata, the temporally-synchronized track identifiers, and/or the computationally-derived features of the set, database or collection 202 of captured audio signal encodings of vocal performances may provide a navigable feature space (or vector space) within which particular attributes or characteristics of the vocal audio recordings (and associated with respective ones of the vocal audio recordings) can be mapped (e.g., using a searchable performance features index). In this manner, digital signal processing techniques, which may be executed by the digital signal processing module 112, can be used to identify and select, by way of the navigable feature space, vocal performances associated with a particular speaker/performer identity, community-applied style tags, likes or follows, genre, popularizing artist, lyrics, geotag location data, gender, age, or backing track identifier, and/or having particular pitch features, quality features, or phoneme features for training AI models (voice cloning models) with vocal audio recordings having the characteristics (e.g., style or character) of a particular target singer or target performance and discovered using the navigable feature space. Further, in at least some embodiments, digital signal processing techniques may be used to identify and select, by way of the navigable feature space, vocal performances having traits associated with multiple performers or multiple tracks (e.g., multiple pitch tracks), where the traits from such multiple performers or multiple tracks can be combined to create a new composited voice.

In some embodiments, the dataset curation process described with reference to FIG. 2 may employ emotion, mood, and expressiveness-based criteria to identify and select the subset of vocal performances 204 from the set, database or collection 202. For example, the digital signal processing module 112 of the content server 110 may extract, from the computer readable encodings of the respective dry vocal performances stored in the set, database or collection 202, computationally-derived emotional or affective features in addition to the pitch features, quality features, phoneme features, and predicted genre previously described. Such emotional or affective features may include, by way of example, a detected emotion classification (e.g., joy, sadness, anger, tenderness, excitement, or melancholy), an energy level or vocal intensity metric derived from amplitude dynamics and spectral energy distribution over time, a breathiness or vocal effort score, a vibrato intensity or frequency, a degree of vocal expressiveness computed from variations in pitch contour, timing, and dynamic range within a given vocal performance, or a mood classification (e.g., upbeat, somber, aggressive, or intimate) inferred from a combination of such features. In some embodiments, the emotional or affective features may be extracted using a neural network model (e.g., such as a CNN, an RNN, an LSTM network, or a self-supervised speech representation learning network) trained to classify or quantify emotional and expressive characteristics of vocal audio.

The extracted emotional or affective features may be associated with respective ones of the vocal performances in the set, database or collection 202 and incorporated into the navigable feature space (or vector space) described with reference to FIG. 2, alongside the metadata (e.g., performer identity, community-applied style tags, likes or follows, genre, popularizing artist, geotag location data, gender, and age), temporally-synchronized track identifiers, and other computationally-derived features (e.g., pitch features, quality features, and phoneme features). In this manner, the digital signal processing module 112 may identify and select, by way of the navigable feature space, a subset of vocal performances 204 that corresponds not only to a target singer, genre, voice type, or musical instrument voice, but also to a target emotional character or expressive quality. For example, the subset of vocal performances 204 may be curated to embody a "melancholic ballad" style by selecting vocal performances that exhibit sadness or tenderness emotion classifications, low-to-moderate energy levels, pronounced breathiness, and slow vibrato, or the subset of vocal performances 204 may be curated to embody a "high-energy celebratory" style by selecting vocal performances that exhibit joy or excitement emotion classifications, high energy levels, and wide dynamic range.

Once selected on the basis of such emotion, mood, and expressiveness-based criteria (alone or in combination with the metadata, temporally-synchronized track identifiers, and other computationally-derived features previously described), the subset of vocal performances 204 may be pre-processed 206 and used to define a prepared training dataset 208 in the manner described above. The one or more AI models of the neural network engine 114 trained using such an emotionally and expressively curated prepared training dataset 208 may thereby learn to generate vocal transformations 117 that not only reproduce the timbral and phonetic characteristics of a target speaker or performer (as reflected in the target speaker/performer identification 306), but also embody the emotional tone, mood, and expressive qualities of the curated subset of vocal performances 204, resulting in transformed vocal performances 117 that convey the target emotional character or expressive quality in addition to the style or character of the target performance.

In some embodiments, the metadata associated with respective ones of the vocal performances in the set, database or collection 202 may further include additional user information such as age-related data and gender-related data associated with the respective performers, as previously noted. The age-related data and gender-related data may be incorporated into the navigable feature space (or vector space) described with reference to FIG. 2, alongside the previously described metadata, temporally-synchronized track identifiers, and other computationally-derived features (e.g., pitch features, quality features, and phoneme features). In this manner, the digital signal processing module 112 may identify and select, by way of the navigable feature space, a subset of vocal performances 204 that corresponds to a target age characteristic, a target gender characteristic, or a combination of age and gender characteristics, in addition to or independently from the other curation criteria previously described. For example, the subset of vocal performances 204 may be curated to embody the vocal characteristics of a young female performer by selecting vocal performances associated with a child or adolescent age range classification and a female gender classification, or the subset of vocal performances 204 may be curated to embody the vocal characteristics of a mature male performer by selecting vocal performances associated with a middle-aged or senior age range classification and a male gender classification. Once selected, the subset of vocal performances 204 may be pre-processed 206 and used to define a prepared training dataset 208 in the manner previously described, such that the one or more AI models of the neural network engine 114 trained using such an age- and gender-curated prepared training dataset 208 may learn the vocal characteristics—including pitch range, timbre, resonance, breathiness, and other acoustic attributes—that are distinctive of the target age and gender profile.

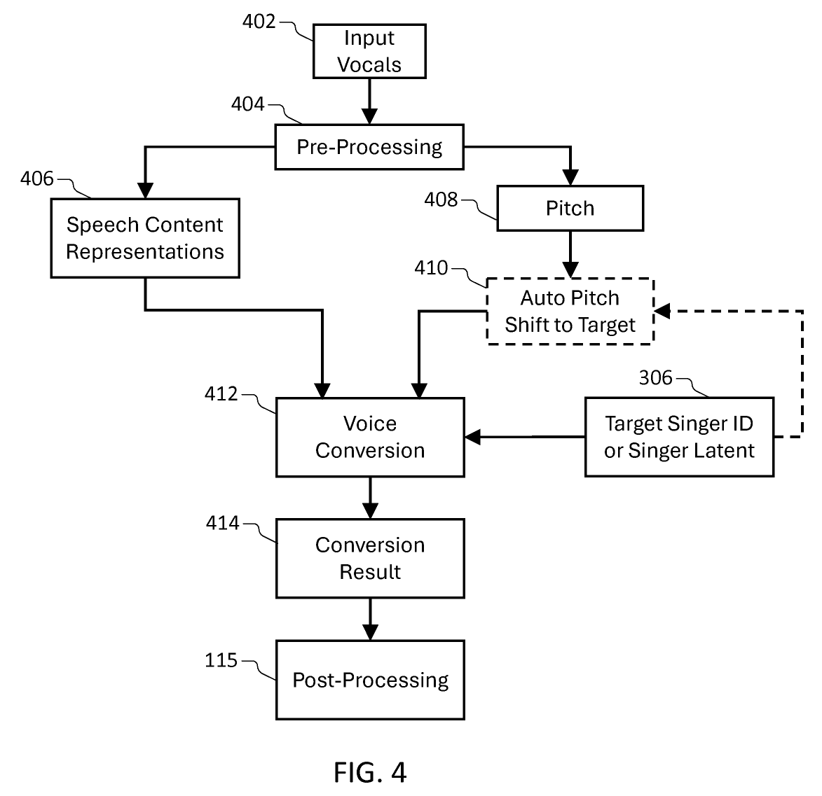

At inference time (e.g., as described below with reference to FIG. 4), a user at handheld 101 may select a target performance style or character that is defined, at least in part, by a target age and/or gender characteristic (e.g., "young female pop vocalist," "mature male baritone," or "child anime character"). The one or more AI models of the neural network engine 114—trained using a prepared training dataset 208 curated to embody the selected target age and gender characteristics as described above—may then perform the vocal transformation by encoding the age- and gender-specific acoustic attributes learned during training into the target speaker/performer identification associated with the selected target performance style or character. The resulting transformed vocal performance 117 may thereby sound as though it were performed by a singer of the target age and gender, while preserving the melodic and linguistic content of the user's original input vocals.

### Pre-processing

Once the selected subset of vocal performances 204 have been identified, and thus once a training set (or training dataset) that embodies the style or character of a particular target singer or target performance, has been defined, individual audio signal encodings (or audio files) of the subset of vocal performances 204 may be pre-processed 206 (such as by digital signal processing module 112 of content server 110) In various embodiments, the pre-processing 206 may perform a pitch range filtering process (e.g., if not already performed during the curation process, as described above), a bleed removal process (e.g., such as to cancel backing track bleed through), equalization of a vocal signal, elimination of extraneous, non-vocal audio, and an audio restoration process (e.g., to repair imperfections and enhance the quality of the audio recordings), an audio segmentation or chunking process, or other such processes.

As part of the pre-processing 206, and if not already performed upon initial uploading of vocal audio (e.g., captured by plural ones of handheld 101A, 101B … 101N) to content server 110, computationally-derived features can also be extracted from each of the dry vocal performances. In some embodiments, the computationally-derived features may include pitch features, quality features, phoneme features, or a predicted genre, as previously described. Further, by way of example, the pitch features may include a vocal pitch estimation or fundamental frequency (f0) estimation. In another example, the quality features may include data regarding track noise, track bleed, volume, and/or others. In some cases, the phoneme features may include phoneme-level representations of the captured vocal audio. In association with the phoneme features, and as a more general description, the computationally-derived features may include speech content representations that include one or more of a textual content, a vocal accent, a vocal timing, and phonemes. In addition to the above, a speaker/performer identification may be extracted from the captured vocal audio, if not previously extracted.

In some examples, one or more of the various pre-processing techniques described herein may be implemented using a neural network model trained to perform respective ones of the various pre-processing techniques. For example, such neural network models may include a convolutional neural network (CNN), a perception neural network, a feed forward neural network, a multilayer perceptron network, a recurrent neural network (RNN), a generative adversarial network (GAN), a radial basis functional neural network, an LSTM (Long Short-Term Memory) network, or other suitable neural network. Depending on the neural network used, and depending on its particular implementation, different sampling rates of the vocal audio used as input to the neural network may be required. As one example, extraction of phoneme-level features may be performed using a self-supervised speech representation learning network that requires input audio signals at a first sampling rate (e.g., 16kHz). On the other hand, the GANs or diffusion models used for vocal transformations may require input audio signals at a second sampling rate (e.g., 40kHz). As a result, during pre-processing 206, two versions of the same captured vocal audio may be saved (e.g., at content server 110), namely a 16kHz version used for computationally-derived feature extraction and a 40kHz version used as a target for the loss function of the GANs or diffusion models used for vocal transformations. In particular, after pre-processing 206, and after resampling at the target sample rate (e.g., 40kHz) of the one or more AI models used by the neural network engine 114 to perform vocal transformations (117), a prepared training dataset 208 is ready to use for training of the one or more AI models. The prepared training dataset 208, by way of example, may include the pre-processed and resampled vocal audio, including computationally-derived features such as pitch and phoneme features, and speaker/performer identification.

In some embodiments, training data augmentation using synthetic audio may be performed in connection with the dataset curation process of FIG. 2. For example, after the selected singer audio files 204 have been identified and pre-processed 206 to produce the prepared training dataset 208, the digital signal processing module 112 or the neural network engine 114 may analyze the prepared training dataset 208 to identify underrepresented characteristics within the curated subset—such as underrepresented pitch ranges, phoneme combinations, vocal timbres, or stylistic inflections relative to the target performance style or character. In response, a generative neural network model, such as a GAN or a diffusion model, which may be the same model being trained or a separate generative model maintained at the content server 110, may be employed to synthesize additional vocal audio recordings that exhibit the underrepresented characteristics while remaining consistent with the computationally-derived features, metadata, and speaker/performer identification associated with the target performance style or character of the curated subset of vocal performances 204. The synthetically generated vocal audio recordings may then be pre-processed 206 in substantially the same manner as the real captured vocal performances—including, for example, bleed removal, equalization, audio restoration, segmentation, and resampling at the target sample rate (e.g., 40kHz) of the one or more AI models of the neural network engine 114—and appended to the prepared training dataset 208 to produce an augmented prepared training dataset. In this manner, the augmented prepared training dataset may provide improved coverage of the feature space associated with the target performance style or character, thereby enabling the one or more AI models trained therewith to produce higher-fidelity vocal transformations 117 that more accurately embody the style or character of the target performance, particularly for input vocals 402 that exhibit pitch ranges, phoneme sequences, or other vocal characteristics that were sparsely represented in the originally curated subset of real vocal performances.

### Model Training

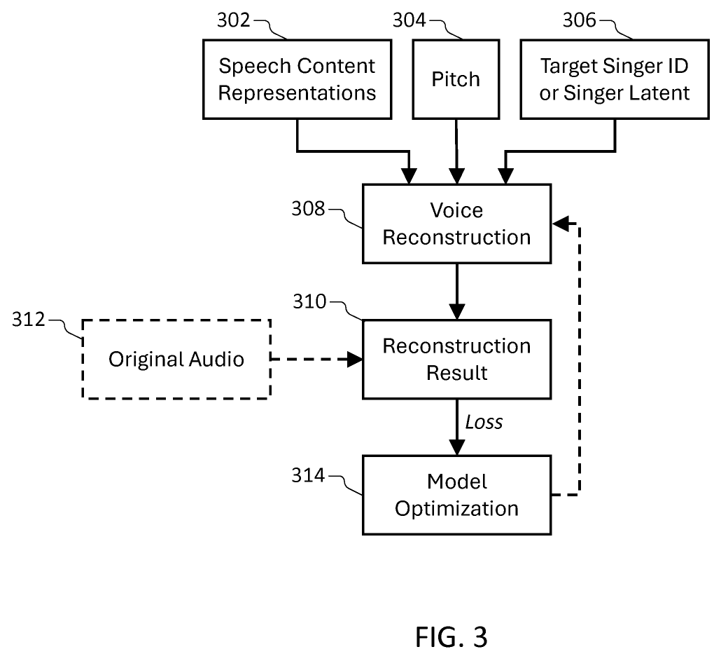

FIG. 3 depicts a general, exemplary training flow for a generative neural network model (e.g., such as a GAN model or a diffusion model) employed in accordance with some embodiments of the present invention. Training the generative model typically involves use of the prepared training dataset 208 (pre-processed and resampled vocal audio, computationally-derived features such as pitch (f0) and phoneme features, and speaker/performer identification). The training dataset 208, like the subset of vocal performances 204 from which it is prepared, embodies the style or character of the particular target singer or target performance and will have an associated speaker/performer identification. With regard to the phoneme features, and as previously described, the computationally-derived features may more generally include speech content representations that include one or more of a textual content, a vocal accent, a vocal timing, and phonemes (or phoneme-level representations of the captured vocal audio).

Referring to the example of FIG. 3, speech content representations 302 (phonemes, etc.), pitch 304 (f0), and a target speaker/performer identification 306 are provided for training an AI model (neural network model) of the neural network engine 114 to perform voice reconstruction 308 of an original audio file 312 associated with the target speaker/performer. In various embodiments, the AI model may include a GAN model, a diffusion model, or other generative AI model. By way of example, the AI model may be trained to perform voice reconstruction 308 based on the speech content representations 302 (including phoneme-level representation), pitch 304 (f0), and target speaker/performer identification 306. As a result, the AI model learns to generate speech/singing that sounds like the target speaker or performer (singer). Since the speech content representations 302 and pitch 304 are agnostic to the speaker, the AI model is forced to learn a speaker/performer representation that can be used to generate audio that sounds like the target speaker or performer. Thereafter, a reconstruction result 310 (of the voice reconstruction 308) and an original audio file 312 can be used to determine a loss (error between the AI model reconstruction and the real captured audio), as calculated by a loss function such as an adversarial loss function, a mean squared estimation error (MSEE), cross-entropy loss, log-loss, and the like.

After determining the loss, a model optimization process 314 is performed, where parameters of the AI model (e.g., weights, biases, etc.) are adjusted and voice reconstruction 308 may be repeated. The AI model training process is an iterative process that aims to minimize the loss and may continue until the AI model achieves a satisfactory level of performance (e.g., such as determined by the loss function and other evaluation metrics). One or more AI models may thus be trained, using prepared training dataset 208 as well as other training datasets, to provide one or more AI models that are trained for use in vocal transformations of captured vocal audio (e.g., of karaoke-style vocal audio captures) into transformed vocal performances that have the style or character of one or more target singers or more generally one or more target performances (e.g., including a target singer, genre, character, a target voice type such as soprano, alto, tenor, or bass, anime, a target musical instrument voice such as sax, electric guitar, etc., or others). For example, trained AI models may be provided for respective ones of plural voice styles, characters, or transformations (e.g., such as a soprano voice-trained AI model, an alto-voice trained AI model, a tenor-voice trained AI model, a bass-voice trained AI model, a female anime-voice trained AI model, a male anime-voice trained AI model, or others). During subsequent karaoke-style vocal audio captures, and in some embodiments, a user may thus select any of the deployed and trained AI models for vocal transformation.

### Model Inference

FIG. 4 depicts a general, exemplary inference flow for a generative neural network model (e.g., such as a GAN model or a diffusion model) deployed in accordance with some embodiments of the present invention. The illustrative inference flow uses an AI model trained, as discussed above, for use in vocal transformations of captured vocal audio (e.g., of karaoke-style vocal audio captures) into transformed vocal performances that have the style or character of a particular target singer or performer. The trained AI model may be deployed at the content server 110 as part of the neural network engine 114. To be sure, in some implementations, the neural network engine 114 (and thus the trained AI model) may be deployed at one or more of the handheld device 101, 101A, 101B … 101N.

At inference time, newly captured vocal audio (e.g., dry vocal audio captured at handheld 101 and uploaded 108 to content server 110) will be provided to the trained AI model as input vocals 402. In some embodiments, the input vocals 402 may be initially pre-processed 404 (such as by digital signal processing module 112) to perform a bleed removal process (e.g., such as to cancel backing track bleed through), equalization of a vocal signal, elimination of extraneous, non-vocal audio, and/or to perform an audio restoration process (e.g., to repair imperfections and enhance the quality of the input vocals 402).

After the input vocals 402 are pre-processed 404, computationally-derived features are extracted from the pre-processed input vocals 402. In some embodiments, the computationally-derived features of the pre-processed input vocals 402 may include at least pitch features 408 and phoneme features (or speech content representations 406). As previously described, such pitch features 408 may include a vocal pitch estimation or fundamental frequency (f0) estimation, and such speech content representations 406 may include one or more of a textual content, a vocal accent, a vocal timing, and phonemes (or phoneme-level representations of the pre-processed input vocals 402. In some embodiments, an auto pitch shift process 410 may optionally be performed to shift the pitch of the input vocals 402 to match the pitch of a target speaker/performer (306).

Thereafter, the speech content representations 406 (phonemes, etc.) and pitch 408 (or optionally, pitch-shifted vocals 410) of the input vocals 402 are provided to a voice conversion module 412 of the trained AI model. In addition, the target speaker/performer identification 306 (for which the particular AI model is trained and/or to which the particular trained AI model is associated) is also provided to the voice conversion module 412 of the trained AI model. The voice conversion module 412 can thereby perform a vocal transformation (or vocal conversion) of an input vocals 402 such that a conversion result 414 (or transformed vocal performance 117) sounds like the target singer, or in other words, will have the style or character of the target performance (e.g., the style or character of the target speaker/performer associated with the target speaker/performer identification 306). By way of example, the voice conversion module 412 (or more generally, the trained AI model) performs the vocal transformation by injecting the target speaker/performer identification 306, while maintaining the speech content representations 406 (phonemes, etc.) and pitch 408 or optionally, pitch-shifted vocals 410) of the input vocals 402. In some embodiments, the target speaker/performer identification 306 injected by the AI model may include a representation of the target speaker or performer’s voice that may be in the form of an associated acoustic model or acoustic attributes of the target speaker/performer (learned by the AI model during the training process) such as timbre, resonance, breathiness, hoarseness, nasality, spectral tilt.

### Post-Processing

After the conversion result 414 is generated, post-processing 115 may optionally be performed to further enhance the generated audio quality. For example, the post-processing 115 may include an upsampling process (or oversampling process), an audio restoration process (e.g., to repair imperfections and enhance the quality of the input vocals 402), or a combination thereof, to enhance the quality of the generated audio. In circumstances in which the generated audio is already of high quality, the post-processing can be used to further enhance the audio quality. In some cases, the post-processing 115 may additionally include an auto volume adjustment process, where a volume of the generated audio is adjusted to match a volume of the source audio (input vocals 402). It is also noted that, like the pre-processing 206 techniques discussed above, one or more of the various pre-processing 404 and post-processing 115 techniques may also be implemented using a neural network model (e.g., such as a CNN, or other suitable neural network model) trained to perform respective ones of the various pre- and post-processing techniques. After post-processing 115, and in some embodiments, the transformed vocal performance 117 may be transmitted to the handheld 101 for rendering by the handheld 101. In some cases, the transformed vocal performance 117 may be mixed, at content server 110, with a backing track to generate a mixed vocal performance that is transmitted to the handheld 101. In other cases, the transformed vocal performance 117 may be mixed, at the handheld 101, with a backing track to generate a mixed vocal performance.

In some embodiments, the vocal transformation described with reference to FIG. 4 may be performed in a real-time, streaming manner rather than as a batch process applied to an entirely pre-recorded dry vocal performance. For example, as input vocals 402 are captured at handheld 101 via a microphone (or via attached or wirelessly-connected ear buds, headphones, or feedback-isolated microphones), the captured vocal audio may be segmented into sequential audio frames or chunks of a predetermined duration (e.g., on the order of tens of milliseconds). Each sequential audio frame may be transmitted to the content server 110 (or, in embodiments where the neural network engine 114 is deployed at the handheld 101, processed locally) substantially in real time as it is captured. Upon receipt of each audio frame, the pre-processing 404 (including bleed removal, equalization, and audio restoration), the extraction of speech content representations 406 and pitch features 408, and the optional auto pitch shift 410 may each be performed on a per-frame or per-chunk basis. The voice conversion module 412 of the trained AI model may then perform the vocal transformation on each pre-processed audio frame, injecting the target speaker/performer identification 306 while maintaining the speech content representations 406 and pitch 408 (or pitch-shifted vocals 410) of the input audio frame, to produce a corresponding frame-level conversion result 414. Post-processing 115 (e.g., upsampling, audio restoration, and auto volume adjustment) may likewise be applied on a per-frame basis. The resulting frame-level transformed audio may then be transmitted back to the handheld 101 (or rendered locally, in on-device inference embodiments) and audibly rendered through the speaker, ear buds, or headphones of the handheld 101, such that the user hears the transformed version of his or her own voice with a total end-to-end latency (from vocal capture to audible rendering of the transformed audio) that is below a perceptually acceptable threshold (e.g., less than approximately 30 milliseconds). In this manner, the user may hear a continuous, real-time rendition of his or her singing voice as transformed into the style or character of the target performance (e.g., the target singer, genre, character, voice type, or musical instrument voice associated with the target speaker/performer identification 306) while the user is still actively performing, thereby providing an interactive and immersive karaoke-style experience.

In some embodiments, the real-time transformed vocal audio may simultaneously be mixed with the backing track 107 on a frame-by-frame basis (either at the content server 110 or at the handheld 101) and the mixed audio rendered to the user in real time. For example, each frame-level conversion result 414, after post-processing 115, may be temporally aligned with the corresponding frame of the backing track 107 and combined into a mixed audio frame that is delivered to the user's audio output device with minimal additional latency. In this manner, the user may experience a fully mixed, karaoke-style performance—including both the transformed vocal and the accompanying backing track 107—in real time as the user sings, without requiring the entire vocal performance to be recorded, transformed, and mixed as a separate, subsequent step. In some embodiments in which the vocal transformation is performed in a real-time, streaming manner, the trained AI model of the neural network engine 114 may employ a causal or autoregressive architecture that processes each audio frame using only current and prior frame data (without requiring future audio frames), thereby enabling low-latency, streaming inference suitable for real-time vocal transformation during a live karaoke-style performance.

### VARIATIONS AND OTHER EMBODIMENTS

While the invention(s) is (are) described with reference to various embodiments, it will be understood that these embodiments are illustrative and that the scope of the invention(s) is not limited to them. Many variations, modifications, additions, and improvements are possible.

### Performance features index, other applications

In some embodiments, the disclosed performance features index may provide a basis for a variety of different features and functionality. For instance, the searchable performance features index can be leveraged to provide a recommendation system that recommends songs to users based on their singing style, a voice cloning system that can clone a user's voice and sing a song in that voice (aspects of which have been disclosed herein), a collaboration system that can match users with similar singing styles and suggest collaborations (e.g., in the context of a social network), a feedback system that can provide feedback on a user's singing style and suggest improvements, a pitch shifting system that can shift the pitch of a user's voice to match a song's key or vice-versa, dataset curation system that can use the user's recordings to create a dataset for training machine learning models (aspect of which have been disclosed herein), and a responsive video generation system that can create special effects videos that react to characteristics of the user's singing.

### Dataset curation, other examples

In another example, while dataset curation may be performed to select a subset of vocal performances 204 to define a training set (or training dataset) that embodies the style or character of the particular target singer or target performance, such dataset curation may also be used to provide other functionality. In one case, a dataset of high-quality recordings may be curated to enable training of AI models that can upsample and restore/enhance low-quality recordings (e.g., such as may be done during post-processing 115). In another example, a dataset of recordings with aligned lyrics may be curated to enable training of AI models that can automatically align lyrics with singing recordings. In still another embodiment, a dataset may be curated to enable voice cloning of any singer/performer that is part of the searchable performance features index (e.g., having vocal audio recordings uploaded to the content server 110). Also, the searchable performance features index may be leveraged to curate a dataset including various combinations of indexed features from multiple performers to create any of a plurality of new, composited voices or performances.

### Model inference, other examples

In another case and for each singer (or performer), an index of performer phonemes may be created based on data extracted from a training dataset. Then, at inference time, phonemes of the source audio (input vocals 402) can be blended with phonemes of the target singer (associated with the target speaker/performer identification 306) in order to bring the generated audio into even closer alignment with the target singer's voice.

### Vocal transformation of spoken-word audio

In some embodiments, the input to the inference pipeline described with reference to FIG. 4 need not be limited to a sung dry vocal performance. For example, a user at handheld 101 may speak, rather than sing, the lyrics of a song, and the spoken-word audio may be provided as input vocals 402 to the trained AI model. In such a spoken-word-to-singing embodiment, the pre-processing 404 may be performed on the spoken-word input in substantially the same manner as described above for sung input vocals 402, including bleed removal, equalization, and audio restoration. Speech content representations 406 (e.g., textual content, phonemes, and vocal timing) and pitch features 408 may then be extracted from the pre-processed spoken-word input. Because the spoken-word input may lack the melodic pitch contour characteristic of a sung vocal performance, the auto pitch shift process 410 may be configured to generate a target melodic pitch contour—for example, derived from a score track, a MIDI representation, or pitch features previously extracted from one or more sung vocal performances in the prepared training dataset 208 associated with the target speaker/performer identification 306—and to map the spoken-word pitch features 408 onto the target melodic pitch contour so as to produce a pitched vocal input suitable for the voice conversion module 412.

The voice conversion module 412 of the trained AI model may then perform the vocal transformation on the pitched spoken-word input by injecting the target speaker/performer identification 306 while maintaining the speech content representations 406 (phonemes, textual content, vocal timing, etc.) extracted from the user's spoken-word input, thereby producing a conversion result 414 that sounds as though the lyrics were sung, rather than spoken, in the style or character of the target performance (e.g., the target singer, genre, character, voice type, or musical instrument voice associated with the target speaker/performer identification 306). Post-processing 115 (e.g., upsampling, audio restoration, and auto volume adjustment) may then be applied to the conversion result 414 to enhance the quality of the generated sung audio. In some embodiments, the resulting transformed vocal performance 117 may thereafter be mixed with the backing track 107 (either at the content server 110 or at the handheld 101) and rendered at the handheld 101, thereby enabling users who are unable or prefer not to sing to nevertheless produce a karaoke-style vocal performance in the style or character of the target performance by simply speaking the lyrics of a song.

### Style blending and interpolation

In some embodiments, rather than selecting a single trained AI model associated with a single target speaker/performer identification 306 for use in the inference pipeline described with reference to FIG. 4, the neural network engine 114 may support blending or interpolation between two or more target performance styles or characters. For example, a user at handheld 101 may select two or more target performance styles or characters (e.g., a first target speaker/performer identification 306 associated with a jazz vocal style and a second target speaker/performer identification 306 associated with an opera soprano vocal style) and specify a blending ratio (e.g., 70% jazz vocalist / 30% opera soprano) via a user interface presented at handheld 101. The content server 110 (or, in embodiments where the neural network engine 114 is deployed at the handheld 101, the handheld 101 itself) may then generate a blended speaker/performer embedding by computing a weighted interpolation of the speaker/performer representations associated with the two or more selected target speaker/performer identifications 306, where the weights correspond to the user-specified blending ratio. The blended speaker/performer embedding may then be provided to the voice conversion module 412 of the trained AI model in place of a single target speaker/performer identification 306, such that the voice conversion module 412 performs the vocal transformation of the input vocals 402 by injecting the blended speaker/performer embedding while maintaining the speech content representations 406 and pitch 408 (or pitch-shifted vocals 410) of the input vocals 402, thereby producing a conversion result 414 that exhibits a hybrid vocal style reflecting the characteristics of the two or more selected target performances in the proportions specified by the blending ratio.

In some embodiments, rather than interpolating speaker/performer embeddings, the style blending may be performed by executing the voice conversion module 412 of two or more separately trained AI models in parallel—for example, a first AI model trained using a first prepared training dataset 208 that embodies a first target performance style or character, and a second AI model trained using a second prepared training dataset 208 that embodies a second target performance style or character. Each of the two or more trained AI models may independently generate a respective conversion result 414 from the same input vocals 402, speech content representations 406, and pitch 408 (or pitch-shifted vocals 410). The neural network engine 114 may then combine the respective conversion results 414 by computing a weighted sum, a weighted average, or other suitable blending function of the audio waveforms or spectral representations of the respective conversion results 414, where the weights correspond to the user-specified blending ratio. Post-processing 115 (e.g., upsampling, audio restoration, and auto volume adjustment) may then be applied to the blended conversion result to produce a transformed vocal performance 117 that reflects a hybrid of the two or more target performance styles or characters.

In some embodiments, the user interface at handheld 101 may present a continuous style-space navigation control (e.g., a slider, a two-dimensional pad, or a multi-axis dial) that enables the user to adjust the blending ratio between the two or more selected target performance styles or characters in real time or prior to initiating the vocal transformation. In this manner, the user may explore a continuous range of hybrid vocal styles rather than being limited to selecting from among discrete, individually trained AI models, thereby expanding the expressive palette available for karaoke-style vocal performances. The resulting transformed vocal performance 117 may thereafter be mixed with a backing track 107 (either at the content server 110 or at the handheld 101) and rendered at the handheld 101 in the manner previously described.

### Style variation within a single performance

In some embodiments, the vocal transformation described with reference to FIG. 4 may employ different target performance styles or characters at different temporal segments within a single vocal performance, rather than applying a single target speaker/performer identification 306 uniformly across the entirety of the input vocals 402. For example, a user at handheld 101 may specify, via a user interface presented at handheld 101, a time-stamped sequence of target performance style selections mapped to corresponding temporal segments of a song (e.g., a first target speaker/performer identification 306 associated with a country vocal style for a verse segment, a second target speaker/performer identification 306 associated with an R&B vocal style for a chorus segment, and a third target speaker/performer identification 306 associated with an opera soprano vocal style for a bridge segment). In some embodiments, the temporal segments may be defined by the user manually (e.g., by specifying start and end timestamps for each segment), or may be determined automatically based on musical structure information derived from the one or more temporally-synchronized tracks (e.g., such as a score track or a backing track 107) associated with the song, such as computationally detected verse, chorus, bridge, and outro boundaries.

At inference time, as the input vocals 402 are pre-processed 404 and the speech content representations 406, pitch features 408, and optional auto pitch shift 410 are extracted, the voice conversion module 412 of the trained AI model may apply the target speaker/performer identification 306 corresponding to each respective temporal segment of the input vocals 402. For example, for audio frames or chunks of the input vocals 402 falling within the verse segment, the voice conversion module 412 may inject the first target speaker/performer identification 306 (e.g., the country vocal style) while maintaining the speech content representations 406 and pitch 408 (or pitch-shifted vocals 410) of those audio frames, thereby producing a conversion result 414 for that segment that has the style or character of the first target performance. Similarly, for audio frames or chunks falling within the chorus segment, the voice conversion module 412 may inject the second target speaker/performer identification 306 (e.g., the R&B vocal style), and for audio frames or chunks falling within the bridge segment, the voice conversion module 412 may inject the third target speaker/performer identification 306 (e.g., the opera soprano vocal style). In this manner, the resulting transformed vocal performance 117 may exhibit a sequence of distinct vocal styles across the timeline of the song, with each temporal segment reflecting the style or character of its respectively assigned target performance.

In some embodiments, to avoid perceptible discontinuities at the boundaries between adjacent temporal segments having different target speaker/performer identifications 306, the neural network engine 114 may apply a crossfade or interpolation of the speaker/performer embeddings associated with the adjacent target speaker/performer identifications 306 over a transition window spanning the boundary between adjacent temporal segments. For example, over a transition window of a predetermined duration (e.g., on the order of hundreds of milliseconds to a few seconds), the voice conversion module 412 may compute a weighted blend of the speaker/performer embeddings of the outgoing and incoming target speaker/performer identifications 306, with the weighting gradually shifting from the outgoing style to the incoming style across the transition window. Post-processing 115 (e.g., upsampling, audio restoration, and auto volume adjustment) may then be applied to the complete sequence of segment-level and transition-level conversion results 414 to produce a seamless transformed vocal performance 117 that exhibits smooth temporal style variation throughout the song. The resulting transformed vocal performance 117 may thereafter be mixed with a backing track 107 (either at the content server 110 or at the handheld 101) and rendered at the handheld 101 in the manner previously described.

### Cross-language and/or cross-accent transformation

In some embodiments, the inference pipeline described with reference to FIG. 4 may be configured to perform a cross-language and/or cross-accent vocal transformation, in which a user at handheld 101 sings in a first language or with a first vocal accent and the trained AI model transforms the input vocals 402 such that the resulting transformed vocal performance 117 sounds as though it were sung in a second, different language or with a second, different vocal accent. Pre-processing 404 may be performed on the input vocals 402 in substantially the same manner as described above (including bleed removal, equalization, and audio restoration), and speech content representations 406—including textual content, phonemes (or phoneme-level representations), vocal accent, and vocal timing—and pitch features 408 may be extracted from the pre-processed input vocals 402. In some examples, a language or accent detection module (which may be implemented as part of the digital signal processing module 112 or as a separate neural network model) may identify the source language or accent of the input vocals 402 based on the extracted speech content representations 406, and a phoneme mapping process may map the source-language phonemes to corresponding target-language phonemes associated with the second language or the second vocal accent.

To support such cross-language and cross-accent transformations, the dataset curation process described with reference to FIG. 2 may employ language-aware or accent-aware curation criteria when selecting the subset of vocal performances 204 from the set, database or collection 202. The metadata associated with the vocal performances may include a language identifier or an accent classification (e.g., English, Spanish, Japanese, Mandarin, or regional accent variants thereof), and may optionally include geotag location data indicating a geographic location at which the vocal performance was captured (e.g., GPS coordinates, country, region, or city associated with the handheld 101 at the time of recording). The computationally-derived features may include language-specific phoneme distributions, accent-discriminative spectral features, or prosodic patterns characteristic of a particular language or accent. The digital signal processing module 112 may then identify and select, by way of the navigable feature space, a subset of vocal performances 204 in which the performers are singing in the target language or with the target accent, such that the prepared training dataset 208 embodies the phonetic, prosodic, and timbral characteristics of vocal performances in the target language or accent. The geotag location data may be used separately from, or in conjunction with, the language identifier, accent classification, and computationally-derived accent-discriminative features as curation criteria—for example, selecting vocal performances geotagged to regions of Latin America for a Latin American Spanish accent, or selecting vocal performances geotagged to the southern United States for a southern American English accent, either as a primary curation criteria or as a supporting curation criteria alongside the language and accent classifiers. In this manner, the one or more AI models of the neural network engine 114 trained using such a language-aware or accent-aware prepared training dataset 208 may learn the phoneme inventory, articulatory patterns, and prosodic patterns specific to the target language or accent.

At inference time, the phoneme mapping process may replace each source-language phoneme in the speech content representations 406 with a corresponding target-language phoneme (or a closest phonetic equivalent where no direct correspondence exists), and the mapped target-language phonemes may be provided, together with the pitch 408 (or pitch-shifted vocals 410) and the target speaker/performer identification 306, to the voice conversion module 412. The voice conversion module 412 may then perform the vocal transformation by injecting the target speaker/performer identification 306 while generating audio that articulates the target-language phonemes with the timing and pitch contour derived from the user's original input vocals 402, thereby producing a conversion result 414 that sounds as though the song were sung in the target language or with the target vocal accent while preserving the melodic characteristics of the user's original performance. Post-processing 115 may then be applied to the conversion result 414, and the resulting transformed vocal performance 117 may be mixed with the backing track 107 (either at the content server 110 or at the handheld 101) and rendered at the handheld 101, thereby enabling a user who sings in a first language or with a first accent to produce a karaoke-style vocal performance that sounds as though it were sung in a second language or with a second accent.

### Aggregation features

In other additional embodiments, and once again leveraging the searchable performance features index, features may be aggregated on a user- or song-level to compute characteristics related to that user or song. For example, pitch features from multiple performances of the same song can be aggregated to compute an estimated pitch track for the song, and the estimated pitch track may then be presented to the user as a guide. In another example, pitch features from multiple performances by the same user can be aggregated to deduce the singing range of the user. In this example, the resulting singing range of the user can then be used to suggest a recommended pitch shift amount or to indicate which songs are in the singing range of the user. In still another example, the estimated word-level onsets from multiple performances of the same song can be aggregated to estimate the expected word-level onsets for the song. In this example, the word-level onsets can then be used for aligning new vocal performances of the song in order to mitigate or erase any latency.

### Visual effects

In other embodiments, such as when performance synchronized video may is captured using an on-board camera provided by handheld 101, various exemplary color correction video effects, mood-denominated video effects, visual blur video effects, and/or augmented reality-type visual effects may be applied to the captured video. In some examples, the augmented reality-type visual effects include object overlays, avatars, synthetic tattoos and other facial embellishments, eye filters, use of reflective surface effects, lyrics-based augmentation and face morphing type effects applied, based on extracted audio features or elements of musical structure, whether coded or computationally-determined. In one example, such as when an avatar is used, the transformed vocal performance 117 may be synchronized with rendered character graphics of the avatar. More generally, in some embodiments, the transformed vocal performance 117 may be synchronized with any of the color correction video effects, mood-denominated video effects, visual blur video effects, and augmented reality-type visual effects, for instance, such that the effects move, are applied/removed, change in intensity, change in color, or are otherwise modified, in coordination with features of the transformed vocal performance 117.

### Duet- and glee club-style performances

In another example, vocal audio of a user (optionally together with performance synchronized video) may in some cases be captured and coordinated with audio (or audiovisual) contributions of other users to form composite duet-style or glee club-style audio (or audiovisual) performances. In some cases, the vocal performances of individual users may be captured (optionally together with performance synchronized video) on portable computing devices (handhelds 101, 101A, 101B … 101N), or using computational facilities of an optionally connected audiovisual display and/or set-top box equipment, in the context of karaoke-style presentations of lyrics in correspondence with audible renderings of a backing track. In some embodiments, a transformed vocal performance 117 may be provided for at least one of the users, such that the transformed vocal performance 117 effectively provides an “AI version” of the at least one user. In this way, a duet-style performance, with contributions from a user and an AI version of the same or different user, may be created. In a similar manner, glee club-style performances, including contributions of one or more AI versions of one or more respective users, may be created. In addition, contributions of multiple vocalists, including both AI versions and non-AI versions of the multiple vocalists, may be coordinated and mixed in a manner that selects for presentation, at any given time along a given performance timeline, performance synchronized video of one or more of the contributors. The selections may provide a sequence of visual layouts in correspondence or coordination with features of the transformed vocal performance 117 or other coded aspects of a performance score such as pitch tracks, backing audio, lyrics, sections and/or vocal parts.

### Social connections and interactions

In some embodiments, aspects of the present disclosure may also leverage social connections and interactions. Such connections and interactions may be visualized using social graphs, which map and analyze relationships within social networks. Social graph data may be extracted or provided from social music networks including applications such as the Smule Ocarina^{TM}, AutoRap®, Sing! Karaoke^{TM} (now Smule^{®} Karaoke), Smule^{®} Style Studio, and Magic Piano^{®} apps available from Smule, Inc., as well as from other social media networks, applications, and platforms. Among other data, social graphs may provide data that reflects user connections and interactions such as friendships, followings, likes, listens, joiners, subscribers, and the like. By leveraging such social graph data (e.g., such as based on social connections and/or social interactions, such as described above), the disclosed system may provide users with the ability to choose (or receive recommendations on), vocal performances by other user(s) of the social music network community that they would like to use for AI model training, where the selected vocal performances have a particular style or character that the user would like to emulate (clone).

In another social-related embodiment, certain business-related operations may be supported. For example, users may be required to subscribe to a particular user’s channel in order to use the particular user’s voice for training or targeting (inference). In some cases, this may provide a mechanism for user monetization of their own vocal performances. In addition, an ecosystem of “ethical AI” can be created, where a user must consent before their voice is used for training or targeting (inference). Persons of skill in the art having benefit of the present disclosure will appreciate a wide variety of other social mechanisms that could be employed within the context of the disclosed embodiments.

While certain illustrative signal processing techniques have been described in the context of certain illustrative applications, persons of ordinary skill in the art will recognize that it is straightforward to modify the described techniques to accommodate other suitable signal processing techniques and effects. Likewise, references to particular data curation techniques, pre- and post-processing algorithms, metadata, temporally-synchronized track identifiers, computationally-derived features, AI model training and inference, and/or other machine learning and/or deep learning techniques are merely illustrative. Persons of skill in the art having benefit of the present disclosure and its teachings will appreciate a range of alternatives to those expressly described.

Embodiments in accordance with the present invention may take the form of, and/or be provided as, one or more computer program products encoded in machine-readable media as instruction sequences and/or other functional constructs of software, which may in turn include components executable on a computational system such as an iPhone handheld, mobile or portable computing device, media application platform or set-top box or on a content server or other service platform to perform methods described herein. In general, a machine readable medium can include tangible articles that encode information in a form (e.g., as applications, source or object code, functionally descriptive information, etc.) readable by a machine (e.g., a computer, a server whether physical or virtual, computational facilities of a mobile or portable computing device, media device or streamer, etc.) as well as non-transitory storage incident to transmission of such applications, source or object code, functionally descriptive information. A machine-readable medium may include, but need not be limited to, magnetic storage medium (e.g., disks and/or tape storage); optical storage medium (e.g., CD-ROM, DVD, etc.); magneto-optical storage medium; read only memory (ROM); random access memory (RAM); erasable programmable memory (e.g., EPROM and EEPROM); flash memory; or other types of medium suitable for storing electronic instructions, operation sequences, functionally descriptive information encodings, etc.

In general, plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the invention(s).

What is claimed is:

1. A method, comprising:
curating a dataset of computer readable encodings of dry vocal performances each captured against one or more respective temporally-synchronized tracks;
based on one or more of correspondence of metadata associated with respective ones of the dry vocal performances, correspondence of a set of computationally-derived features extracted from the computer readable encodings of respective dry vocal performances, and correspondence of amongst one or more of the respective temporally-synchronized tracks against which respective ones of the dry vocal performances were captured, selecting from the dataset a subset of the dry vocal performances as a first training set that embodies a first target performance style or character; and
using a first trained neural network model trained with the first training set, generating from at least speech content representations extracted from a newly captured dry vocal performance, a transformed vocal performance corresponding to the newly captured dry vocal performance but with the style or character of the first target performance.

2. The method of claim 1, further comprising:
using a second trained neural network model trained with a second training set, generating from at least speech content representations extracted from the newly captured dry vocal performance, a second transformed vocal performance corresponding to the newly captured dry vocal performance but with the style or character of a second target performance, wherein the second training set is a second subset of the dry vocal performances selected from the dataset that embodies the second target performance style or character.

3. The method of claim 1, wherein selecting from the dataset includes selecting plural subsets of the dry vocal performances as respective plural training sets that each embody a respective target performance style or character, and wherein the method further comprises:
selecting, from amongst plural trained neural network models trained with one of the respective plural training sets, a second trained neural network model; and
using the second trained neural network model, generating from at least speech content representations extracted from the newly captured dry vocal performance, a second transformed vocal performance corresponding to the newly captured dry vocal performance but with the style or character of the respective target performance.

4. The method of claim 1, further comprising:
capturing the newly captured dry vocal performance and generating the transformed vocal performance at a mobile audiovisual capture device.

5. The method of claim 1, further comprising:
receiving a computer readable encoding of the newly captured dry vocal performance at a service platform from a mobile audiovisual capture device;
generating the transformed vocal performance at the service platform; and
supplying a computer readable encoding of the transformed vocal performance to the mobile audiovisual capture device for audible rendering thereon.

6. The method of claim 1, wherein the temporally-synchronized tracks include one or more of a backing track, a score track, and a lyrics track against which the respective dry vocal performance was captured.

7. The method of claim 1, wherein the metadata encodes one or more of performer identity, community-applied style tags, likes or follows, genre, popularizing artist, geotag location data, gender, age, and backing track identifier.

8. The method of claim 1, wherein the computationally-derived features include one or more of pitch features, quality features, phoneme features, or a predicted genre.

9. The method of claim 8, wherein the computationally-derived features further include emotional or affective features.

10. The method of claim 1, wherein the first target performance style or character embodied by the first training set characterizes performances of a particular performer.

11. The method of claim 1, wherein the first target performance style or character embodied by the first training set corresponds to a particular vocal style, cadence or tonal quality.

12. The method of claim 1, further comprising:
pre-processing at least some of the computer readable encodings of the respective dry vocal performances using a neural network model trained to cancel backing track bleed through, equalize a vocal signal and/or eliminate extraneous, non-vocal audio.

13. The method of claim 1, wherein the first trained neural network model includes a generative adversarial network (GAN) or a diffusion model.

14. The method of claim 1, wherein the speech content representations include one or more of a textual content, a vocal accent, a vocal timing, and phonemes.

15. The method of claim 1, further comprising:
mixing the transformed vocal performance with a backing track to generate a mixed vocal performance.

16. The method of claim 15, wherein the mixing the transformed vocal performance with the backing track to generate the mixed vocal performance is performed at a mobile audiovisual capture device.

17. The method of claim 15, wherein the mixing the transformed vocal performance with the backing track to generate a mixed vocal performance is performed at a service platform.

18. The method of claim 1, wherein the first training set includes vocal audio that is synthetically generated based on the subset of the dry vocal performances.

19. The method of claim 1, wherein the transformed vocal performance is generated in a real-time during capture of the newly captured dry vocal performance.

20. The method of claim 1, wherein the newly captured dry vocal performance includes spoken-word audio.

21. The method of claim 1, wherein the transformed vocal performance includes a hybrid vocal style corresponding to the newly captured dry vocal performance but with the style or character of both the first target performance and a second target performance.

22. The method of claim 1, wherein a first temporal segment of the transformed vocal performance corresponds to the newly captured dry vocal performance but with the style or character of the first target performance, and wherein a second temporal segment of the transformed vocal performance corresponds to the newly captured dry vocal performance but with the style or character of a second target performance.

23. The method of claim 1, wherein the transformed vocal performance includes vocal audio corresponding to a language or an accent different than that of the newly captured dry vocal performance.

24. A computer program product encoded in one or more media, the computer program product including instructions executable on one or more processors to perform the method of claim 1.

25. A method, comprising:
accessing computer readable encodings of respective dry vocal performances each captured in connection with one or more respective temporally-synchronized tracks;
extracting a set of computationally-derived features and metadata from each of the computer readable encodings of the respective dry vocal performances;
selecting from the computer readable encodings of the respective dry vocal performances, a subset of the dry vocal performances to define a training dataset, wherein the subset of dry vocal performances is selected for correspondence with at least one of the computationally-derived features and the metadata of the respective dry vocal performances;
training a neural network model using the training dataset to generate a trained neural network model;
receiving a newly captured computer readable encoding of a dry vocal performance; and
converting, using the trained neural network model, the newly captured dry vocal performance into a modified vocal performance corresponding to the newly captured dry vocal performance but having correspondence with the at least one of the computationally-derived features and the metadata of the respective dry vocal performances.

26. The method of claim 25, further comprising:
selecting from the computer readable encodings of the respective dry vocal performances, a second subset of the dry vocal performances to define a second training dataset, wherein the second subset of dry vocal performances is selected for correspondence with at least a different one of the computationally-derived features and the metadata of the respective dry vocal performances;
training a second neural network model using the second training dataset to generate a second trained neural network model; and
converting, using the second trained neural network model, the newly captured dry vocal performance into a second modified vocal performance corresponding to the newly captured dry vocal performance but having correspondence with the at least the different one of the computationally-derived features and the metadata of the respective dry vocal performances.

27. The method of claim 25, further comprising:
selecting from the computer readable encodings of the respective dry vocal performances, plural subsets of the dry vocal performances to define respective plural training datasets, wherein each of the plural subsets of the dry vocal performances are selected for correspondence with respective sets of the computationally-derived features and the metadata of each the respective dry vocal performances;
training plural neural network models using the respective plural training datasets to generate plural trained neural network models; and
converting, using a selected one of the plural trained neural network models, the newly captured dry vocal performance into a second modified vocal performance corresponding to the newly captured dry vocal performance but having correspondence with the respective set of the computationally-derived features and the metadata of the respective dry vocal performances of a respective training dataset used to train the selected one of the plural trained neural network models.

28. The method of claim 25, further comprising:
prior to training the neural network model, performing one or more of a pitch range filtering process, a bleed removal process, and an audio restoration process to the subset of dry vocals of the dataset to define a pre-processed dataset; and
training the neural network model using the pre-processed dataset to generate the trained neural network model.

29. The method of claim 25, further comprising:
capturing the newly captured computer readable encoding of the dry vocal performance at a mobile handheld device.

30. The method of claim 29, wherein the converting the newly captured dry vocal performance into the modified vocal performance is performed at the mobile handheld device.

31. The method of claim 29, wherein the converting the newly captured dry vocal performance into the modified vocal performance is performed at a service platform.

32. The method of claim 25, further comprising:
mixing the modified vocal performance with a backing track to generate a mixed vocal performance.

33. A computer program product encoded in one or more media, the computer program product including instructions executable on one or more processors to perform the method of claim 25.

34. A method, comprising:
capturing, via a microphone of a portable computing device, a vocal audio performance of a user of the portable computing device captured in connection with one or more respective temporally-synchronized tracks;
transmitting a computer readable encoding of the vocal audio performance and a selection of a style or character of a target performance to a service platform; and
receiving, from the service platform for rendering at the portable computing device, a transformed vocal audio performance corresponding to the captured vocal audio performance of the user but with the style or character of the target performance;
wherein the transformed vocal audio performance includes an output of a neural network model trained with a training dataset comprising previously recorded dry vocal performances each corresponding with at least one of plural computationally-derived features and metadata of the previously recorded dry vocal performances, and wherein the training dataset embodies the style or character of the target performance.

35. A system, comprising:
a geographically distributed set of network-connected devices configured to capture vocal audio performances captured in connection with a temporally-synchronized track; and
a service platform configured to (i) curate a dataset of computer readable encodings of dry vocal performances each captured against one or more respective temporally-synchronized tracks, (ii) based on one or more of correspondence of metadata associated with respective ones of the dry vocal performances, correspondence of a set of computationally-derived features extracted from the computer readable encodings of respective dry vocal performances, and correspondence of amongst one or more of the respective temporally-synchronized tracks against which respective ones of the dry vocal performances were captured, selecting from the dataset a subset of the dry vocal performances as a first training set that embodies a first target performance style or character, and (iii) using a first trained neural network model trained with the first training set, generating from at least speech content representations extracted from a newly captured dry vocal performance captured from one of the geographically distributed set of network-connected devices, a transformed vocal performance corresponding to the newly captured dry vocal performance but with the style or character of the first target performance.

36. The system of claim 35, wherein the service platform is further configured to transmit the transformed vocal performance to the one of the geographically distributed set of network-connected devices.

37. A system, comprising:
a geographically distributed set of network-connected devices configured to capture vocal audio performances captured in connection with a temporally-synchronized track; and
a service platform configured to (i) access computer readable encodings of respective dry vocal performances each captured in connection with one or more respective temporally-synchronized tracks, (ii) extract a set of computationally-derived features and metadata from each of the computer readable encodings of the respective dry vocal performances, (iii) select from the computer readable encodings of the respective dry vocal performances, a subset of the dry vocal performances to define a training dataset, wherein the subset of dry vocal performances is selected for correspondence with at least one of the computationally-derived features and the metadata of the respective dry vocal performances, (iv) train a neural network model using the training dataset to generate a trained neural network model, (v) receive a newly captured computer readable encoding of a dry vocal performance from at least one of the geographically distributed set of network-connected devices, and (vi) convert, using the trained neural network model, the newly captured dry vocal performance into a modified vocal performance corresponding to the newly captured dry vocal performance but having correspondence with the at least one of the computationally-derived features and the metadata of the respective dry vocal performances.

38. The system of claim 37, wherein the service platform is further configured to transmit the modified vocal performance to the at least one of the geographically distributed set of network-connected devices.

39. A method, comprising:
extracting, from computer readable encodings of dry vocal performances each captured in connection with one or more respective temporally-synchronized tracks, performance features associated with each of the dry vocal performances;
creating a searchable performance features index for storing the extracted performance features associated with each of the dry vocal performances;
searching the searchable performance features index to select a subset of dry vocal performances that each correspond to a chosen criteria of the extracted performance features, wherein the selected subset of dry vocal performance defines a training dataset that embodies a target performance style or character associated with the chosen criteria; and
using a trained neural network model trained with the training dataset, generating from at least speech content representations extracted from a newly captured dry vocal performance, a transformed vocal performance corresponding to the newly captured dry vocal performance but with the style or character of the target performance.

40. The method of claim 39, further comprising:
receiving a selection of the chosen criteria from a mobile audiovisual capture device; and
based on the selection, searching the searchable performance features index to select the subset of dry vocal performances that each correspond to the chosen criteria of the extracted performance features.

41. The method of claim 39, wherein the extracted performance features include computationally-derived features and metadata.

42. The method of claim 39, wherein the chosen criteria is associated with traits from multiple performers or multiple tracks.
